(19) United States
(12) Patent Application Publication
(10) Pub. No.: US 2021/0195935 A1
(43) Pub. Date: Jul. 1, 2021

(54) MULTI-TEXTURED LAYERED FOOD PRODUCTS AND METHODS OF MAKING TO MAINTAIN TEXTURE WITHOUT THE USE OF A BARRIER

(71) Applicant: KRAFT FOODS GROUP BRANDS LLC, Chicago, IL (US)

(72) Inventor: Allison Therese Nowak, Elk Grove Village, IL (US)

(21) Appl. No.: 16/729,766

(22) Filed: Dec. 30, 2019

(51) Int. Cl. A23P 20/10; A23D 9/007; A23G 3/34; A23P 20/20

(52) U.S. Cl. CPC A23P 20/11; A23P 20/20; A23G 3/343; A23D 9/007

(57) ABSTRACT

A multilayer edible product includes a first layer and a second layer having a water activity that may be greater than the water activity of the first layer. The first layer may include high-melting fat and may mitigate moisture migration from the second layer to the first layer.

### BACKGROUND

### Field

The present specification generally relates to multilayer edible products having a first, dry layer and a second, wet layer without a barrier layer positioned between the first layer and the second layer. In particular, the present specification relates to first, dry layers that include high-melting fats and mitigate moisture migration from the second layer to the first layer.

### Technical Background

Moisture migration from one layer of an edible food product to another layer of the edible food product due to water activity gradients is a problem in typical multilayer food products. This moisture migration may result in unstable products with short shelf lives and may cause microbial or product quality issues.

Accordingly, a need exists for multilayer edible products that prevent migration of moisture from layer to layer of the multilayer edible products, and particularly prevents the migration of moisture from a layer having a higher water activity to a layer having a lower water activity.

### SUMMARY

According to one embodiment, a multilayer edible product comprises a first layer having a water activity from 0.2 to 0.4; and a second layer having a water activity greater than 0.75. The first layer comprises high-melting fat and mitigates moisture migration from the second layer to the first layer.

In another embodiment, a multilayer edible product comprises a first layer comprising crumb particulates, a compound coating, and a fat source; and a second layer comprising one or more gelled substances, a flavoring component, and thickening agent. The first layer comprises high-melting fat and may be configured to prevent moisture migration from the second layer to the first layer.

Additional features and advantages of the multilayer edible products described herein and methods for making the same will be set forth in the detailed description which follows, and will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWING

FIG. 1 is a schematic depiction of a cross section of a multilayer edible product according to embodiments disclosed and described herein.

### DETAILED DESCRIPTION

Reference will now be made in detail to various embodiments of multilayer edible products comprising a first, dry layer and a second, wet layer without an edible moisture barrier layer positioned between the first layer and the second layer. According to embodiments, a multilayer edible product comprises a first layer having a water activity from 0.20 to 0.40 and a second layer having a water activity greater than 0.75. The first layer comprises high-melting fat and mitigates moisture migration from the second layer to the first layer. Various embodiments of multilayer edible products comprising a first, dry layer and a second, wet layer will now be described with reference to the appended drawings.

Unless otherwise specified, a range of values, when recited, includes both the upper and lower limits of the range as well as any ranges there between. As used herein, the indefinite articles “a,” “an,” and the corresponding definite article “the” mean “at least one” or “one or more,” unless otherwise specified. It also is understood that the various features disclosed in the specification and the drawings can be used in any and all combinations.

As used herein, the term “about” means both the precise number it precedes as well as variants of that precise number that would be envisioned by a person of ordinary skill in the art to provide similar effects as the precise number. For example, a range from “about 10 to about 20” includes a range from 10 to 20, and also includes variants below 10 that would be envisioned by a person of ordinary skill in the art to provide similar effects as 10 and includes variants above 20 that would be envisioned by a person of ordinary skill in the art to provide similar effects as 20.

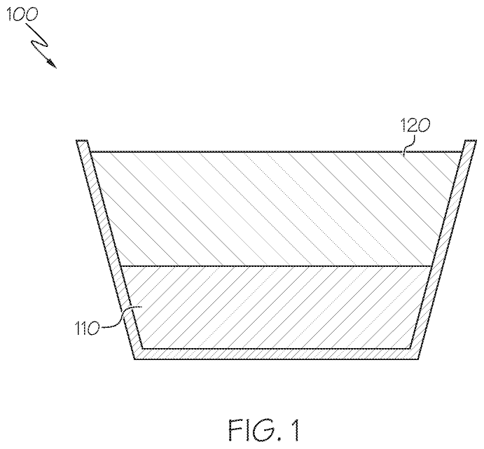

With reference now to FIG. 1, a cross section of a multilayer edible product 100 comprises a first, dry layer 110 and a second, wet layer 120. Although the embodiment of the multilayer edible product 100 depicted in FIG. 1 is rectangular in shape, it should be understood that in embodiments, the multilayer edible product 100 may have any suitable geometrical shape. The second layer 120 may be positioned on, and in physical contact with, the first layer 110. It should be appreciated that while one first, dry layer 110 and one second, wet layer 120 are depicted in FIG. 1, any number of first, dry or second, wet layers may be in contact with each other in accordance with the present disclosure. It should further be appreciated that the layers may be placed in any order provided that at least one wet layer is adjacent to at least one dry layer. For instance, and without limitation, one second, wet layer may be between and in contact with two first, dry layers. As mentioned hereinabove, without specific formulations for the dry and wet layers, moisture has a tendency to migrate from the second, wet layer 120 to the first, dry layer 110 of the multilayer edible product 100 when the first layer 110 has a lower water activity than the second layer 120.

The First Layer

As described above, the first, dry layer 110 of the multilayer edible product 100 may be in contact with, according to embodiments, the second, wet layer 120. According to embodiments, the first layer 110 of the multilayer edible product 100 has a water activity that is less than the water activity of the second layer 120. As described above, when there is a water activity differential between the first layer 110 and the second layer 120 (such as when the water activity of the first layer 110 is less than the water activity of the second layer 120), moisture may migrate from the second layer 120 to the first layer 110. It should be understood that the greater the difference between the water activity of the first layer 110 and the second layer 120, the more pronounced the migration of moisture may be.

The composition of the first layer 110 will typically have a water activity that is less than the water activity of the second layer 120. In embodiments, the first layer 110 may comprise crumb particulates, a compound coating, and a fat source. The crumb particulates may decrease the water activity of the first layer 110 so that it is less than the water activity of the second layer 120. Accordingly, in embodiments, the first layer 110 comprises crumb particulates. As used herein, the term “crumb particulates” means fragments of a grain-based carbohydrate element. The grain-based carbohydrate element may, according to embodiments, comprise barley, oats, rice, rye, wheat, or combinations thereof. As such, the term “crumb particulates” may refer to any suitable edible fragment of baked goods, such as breadcrumbs, cake crumbs, cookie crumbs, crackers, or combinations thereof. In embodiments, the first layer 110 may also include small concentrations of one or more additional elements, such as nuts, for instance. The nuts, according to embodiments, may comprise hazelnuts, chestnuts, almonds, cashews, walnuts, peanuts, pecans, or any other fruit or seed generally referred to as a nut in the culinary sense.

In embodiments where the first layer 110 comprises crumb particulates, the crumb particulates are pulverized into a desired particle size. As should be understood, the particle size of the crumb particulates will affect the consistency and overall mouth feel of the first layer 110 of the multilayer edible product 100. For instance, if the particle size of the crumb particulates is too large, the first layer 110 will be gritty and may have an unpleasant mouth feel. As the particle size of the crumb particulates decreases, the compound coating and fat source of the first layer 110, when melted, are more able to coat the entirety of each crumb particulate, which reduces the moisture migration from the second layer 120 to the first layer 110. In embodiments, the crumb particulates may be pulverized by any conventional mechanism, such as grinding, milling, pressing, jet milling, food processing, mortar and pestle, and the like. According to embodiments, the crumb particulates may be pulverized such that a median particle size distribution, D₅₀, as measured by laser diffraction, may be less than or equal to about 20.0 μm, such as less than or equal to about 18.0 μm, less than or equal to about 15.0 μm, less than or equal to about 12.0 μm, less than or equal to about 10.0 μm, less than or equal to about 8.0 μm, or less than or equal to about 5.0 μm. Thus, according to embodiments, the crumb particulates may be pulverized such that a median particle size distribution, D₅₀, may be from greater than or equal to about 2.0 μm to less than or equal to about 20.0 μm, such as from greater than or equal to about 5.0 μm to less than or equal to about 18.0 μm, from greater than or equal to about 10.0 μm to less than or equal to about 16.0 μm, or from greater than or equal to about 12.0 μm to less than or equal to about 14.0 μm, or about 15.0 μm.

According to embodiments, the crumb particulates may be pulverized such that a particle size distribution, D₉₀, as measured by laser diffraction, may be less than or equal to about 45.0 μm, such as less than or equal to about 42.0 μm, less than or equal to about 40.0 μm, less than or equal to about 38.0 μm, or less than or equal to about 35.0 μm. Thus, according to embodiments, the crumb particulates may be pulverized such that a particle size distribution, D₉₀, may be from greater than or equal to about 30.0 μm to less than or equal to about 45.0 μm, such as from greater than or equal to about 35.0 μm to less than or equal to about 42.0 μm, or from greater than or equal to about 38.0 μm to less than or equal to about 40.0 μm.

In embodiments, according to sieve analysis, the crumb particulates may be pulverized such that a U.S. screen #20 retains from greater than or equal to 20.0 wt % of the crumb particulates, such as greater than or equal to about 22.5 wt %, greater than or equal to about 25.0 wt %, or greater than or equal to about 27.5 wt %. For each of the above ranges, the maximum amount of crumb particulates retained by U.S. screen #20 may be, according to embodiments, about 30.0 wt %. Accordingly, in embodiments, U.S. screen #20 may retain from greater than or equal to about 20.0 wt % of the crumb particulates to less than or equal to about 30.0 wt %, such as from greater than or equal to about 22.5 wt % to less than or equal to about 30.0 wt %, from greater than or equal to about 25.0 wt % to less than or equal to about 30.0 wt %, or from greater than or equal to about 27.5 wt % to less than or equal to about 30.0 wt %. In embodiments, U.S. screen #20 may retain from greater than or equal to about 20.0 wt % to less than or equal to about 30.0 wt %, from greater than or equal to about 21.0 wt % to less than or equal to about 29.0 wt %, from greater than or equal to about 22.0 wt % to less than or equal to about 28.0 wt %, from greater than or equal to about 23.0 wt % to less than or equal to about 27.0 wt %, or from greater than or equal to about 24.0 wt % to less than or equal to about 26.0 wt %.

In embodiments, according to sieve analysis, the crumb particulates may be pulverized such that a U.S. screen #40 retains from greater than or equal to 30.0 wt % of the crumb particulates, such as greater than or equal to about 32.5 wt %, greater than or equal to about 35.0 wt %, greater than or equal to about 37.5 wt %, as greater than or equal to about 40.0 wt %, greater than or equal to about 42.5 wt %, greater than or equal to about 45.0 wt %, or greater than or equal to about 47.5 wt %. For each of the above ranges, the maximum amount of crumb particulates retained by U.S. screen #40 may be, according to embodiments, about 50.0 wt %. Accordingly, in embodiments, U.S. screen #40 may retain from greater than or equal to about 30.0 wt % of the crumb particulates to less than or equal to about 50.0 wt %, such as from greater than or equal to about 32.5 wt % to less than or equal to about 50.0 wt %, from greater than or equal to about 35.0 wt % to less than or equal to about 50.0 wt %, from greater than or equal to about 37.5 wt % to less than or equal to about 50.0 wt %, from greater than or equal to about 40.0 wt % to less than or equal to about 50.0 wt %, from greater than or equal to about 42.5 wt % to less than or equal to about 50.0 wt %, from greater than or equal to about 45.0 wt % to less than or equal to about 50.0 wt %, or from greater than or equal to about 47.5 wt % to less than or equal to about 50.0 wt %. In embodiments, U.S. screen #40 may retain from greater than or equal to about 30.0 wt % to less than or equal to about 50.0 wt %, from greater than or equal to about 32.5 wt % to less than or equal to about 47.5 wt %, from greater than or equal to about 35.0 wt % to less than or equal to about 45.0 wt %, from greater than or equal to about 37.5 wt % to less than or equal to about 42.5 wt %, or from greater than or equal to about 39.0 wt % to less than or equal to about 41.0 wt %.

In embodiments, according to sieve analysis, the crumb particulates may be pulverized such that a U.S. screen #80 retains from greater than or equal to 30.0 wt % of the crumb particulates, such as greater than or equal to about 32.5 wt %, greater than or equal to about 35.0 wt %, greater than or equal to about 37.5 wt %, as greater than or equal to about 40.0 wt %, greater than or equal to about 42.5 wt %, greater than or equal to about 45.0 wt %, or greater than or equal to about 47.5 wt %. For each of the above ranges, the maximum amount of crumb particulates retained by U.S. screen #80 may be, according to embodiments, about 50.0 wt %. Accordingly, in embodiments, U.S. screen #80 may retain from greater than or equal to about 30.0 wt % of the crumb particulates to less than or equal to about 50.0 wt %, such as from greater than or equal to about 32.5 wt % to less than or equal to about 50.0 wt %, from greater than or equal to about 35.0 wt % to less than or equal to about 50.0 wt %, from greater than or equal to about 37.5 wt % to less than or equal to about 50.0 wt %, from greater than or equal to about 40.0 wt % to less than or equal to about 50.0 wt %, from greater than or equal to about 42.5 wt % to less than or equal to about 50.0 wt %, from greater than or equal to about 45.0 wt % to less than or equal to about 50.0 wt %, or from greater than or equal to about 47.5 wt % to less than or equal to about 50.0 wt %. In embodiments, U.S. screen #80 may retain from greater than or equal to about 30.0 wt % to less than or equal to about 50.0 wt %, from greater than or equal to about 32.5 wt % to less than or equal to about 47.5 wt %, from greater than or equal to about 35.0 wt % to less than or equal to about 45.0 wt %, from greater than or equal to about 37.5 wt % to less than or equal to about 42.5 wt %, or from greater than or equal to about 39.0 wt % to less than or equal to about 41.0 wt %.

According to embodiments, the first layer 110 may comprise from about 50 wt % to about 70 wt % of the crumb particulates, from about 10 wt % to about 30 wt % of the compound coating, and from about 10 wt % to about 30 wt % of the fat source. Each of the crumb particulate, compound coating, and the fat source will be described in more detail below.

According to embodiments, the first layer 110 may comprise greater than or equal to about 50.0 wt % of the crumb particulates, such as greater than or equal to about 52.5 wt % of the crumb particulates, greater than or equal to about 55.0 wt % of the crumb particulates, greater than or equal to about 57.5 wt % of the crumb particulates, greater than or equal to about 60.0 wt % of the crumb particulates, greater than or equal to about 62.5 wt % of the crumb particulates, greater than or equal to about 65.0 wt % of the crumb particulates, or greater than or equal to about 67.5 wt % of the crumb particulates.

For each of the above ranges, the maximum content of crumb particulates present in the first layer 110 may be, according to embodiments, about 70.0 wt %. Accordingly, in embodiments, the content of the crumb particulates in the first layer 110 may be from greater than or equal to about 50.0 wt % to less than or equal to about 70.0 wt %, such as from greater than or equal to about 52.5 wt % to less than or equal to about 70.0 wt %, from greater than or equal to about 55.0 wt % to less than or equal to about 70.0 wt %, from greater than or equal to about 57.5 wt % to less than or equal to about 70.0 wt %, from greater than or equal to about 60.0 wt % to less than or equal to about 70.0 wt %, from greater than or equal to about 62.5 wt % to less than or equal to about 70.0 wt %, from greater than or equal to about 65.0 wt % to less than or equal to about 70.0 wt %, or from greater than or equal to about 67.5 wt % to less than or equal to about 70.0 wt %. In embodiments, the content of the crumb particulates present in the first layer 110 may be from greater than or equal to about 52.0 wt % to less than or equal to about 68.0 wt %, such as from greater than or equal to about 54.0 wt % to less than or equal to about 66.0 wt %, from greater than or equal to about 55.0 wt % to less than or equal to about 65.0 wt %, from greater than or equal to about 56.0 wt % to less than or equal to about 64.0 wt %, from greater than or equal to about 58.0 wt % to less than or equal to about 62.0 wt %, or from greater than or equal to about 59.0 wt % to less than or equal to about 61.0 wt %.

As disclosed above, the first layer 110 may comprise a compound coating. As used herein, the term “compound coating” may be used broadly to refer to any suitable agent that provides the first layer 110 with additional flavoring. As such, the term “compound coating” may refer to any suitable substance that includes edible oil and hydrophilic powder. In embodiments, the compound coating may further comprise whey, lecithin, salt, or combinations thereof.

The edible oil present in the compound coating of the first layer 110 may include any suitable high-melting fat or derivations thereof. As described herein, the term “high-melting fat” means fats with high concentrations of saturated fatty acids and longer hydrocarbon chains. Typically, high-melting fats are solid at ambient temperatures and have melting points greater than or equal to 30° C. The high-melting fats may be naturally existing or be a product of hydrogenation. Fats with trans fatty acids, such as those having a “trans” configuration, may also be included within this definition. However, embodiments of the high-melting fat do not have a trans configuration. The high-melting fat may, according to embodiments, comprise coconut oil, anhydrous milk fat, palm oil, chocolate, cocoa butter, fractionated palm oil, double fractionated palm oil, fully hydrogenated coconut palm and palm kernel oils, palm kernel oil, interesterified vegetable oil, partially hydrogenated oil, animal fat, shortening, or combinations thereof. In some embodiments, high-melting fat comprises coconut oil, anhydrous milk fat, palm oil, chocolate, or combinations thereof. The high-melting fat in the compound coating may mitigate the migration of moisture from the second layer 120 to the first layer 110. Therefore, if too little high-melting fat is present, moisture may migrate at unacceptable levels. However, if too much high-melting fat is included, the mouthfeel, palatability, and flavor will not be suitable. In embodiments, therefore, the compound coating may comprise from greater than or equal to about 50.0 wt % of the high-melting fat, such as greater than or equal to about 52.5 wt % of the high-melting fat, greater than or equal to 55.0 wt % of the high-melting fat, greater than or equal to about 57.5 wt % of the high-melting fat, greater than or equal to about 60.0 wt % of the high-melting fat, greater than or equal to about 62.5 wt % of the high-melting fat, greater than or equal to about 65.0 wt % of the high-melting fat, or greater than or equal to about 67.5 wt % of the high-melting fat.

For each of the above ranges, the maximum content of the high-melting fat present in the compound coating may be, according to embodiments, about 70.0 wt %. Accordingly, in embodiments, the content of the high-melting fat in the compound coating may be from greater than or equal to about 50.0 wt % to less than or equal to about 70.0 wt %, such as from greater than or equal to about 52.5 wt % to less than or equal to about 70.0 wt %, from greater than or equal to about 55.0 wt % to less than or equal to about 70.0 wt %, from greater than or equal to about 57.5 wt % to less than or equal to about 70.0 wt %, from greater than or equal to about 60.0 wt % to less than or equal to about 70.0 wt %, from greater than or equal to about 62.5 wt % to less than or equal to about 70.0 wt %, from greater than or equal to about 65.0 wt % to less than or equal to about 70.0 wt %, or from greater than or equal to about 67.5 wt % to less than or equal to about 70.0 wt %. In embodiments, the content of the high-melting fat present in the compound coating may be from greater than or equal to about 52.0 wt % to less than or equal to about 68.0 wt %, such as from greater than or equal to about 54.0 wt % to less than or equal to about 66.0 wt %, from greater than or equal to about 55.0 wt % to less than or equal to about 65.0 wt %, from greater than or equal to about 56.0 wt % to less than or equal to about 64.0 wt %, from greater than or equal to about 58.0 wt % to less than or equal to about 62.0 wt %, or from greater than or equal to about 59.0 wt % to less than or equal to about 61.0 wt %.

Likewise, the hydrophilic powder present in the compound coating of the first layer 110 may include any suitable sugar, derivations or extracts thereof, or sugar replacers. In embodiments, the hydrophilic powder may comprise confectioners' sugar, brown sugar, granulated sugar, invert sugar, milled sugar, artificial sweeteners such as, sucralose, acesulfame potassium, saccharine, or aspartame, natural high-intensity sweeteners such as monk fruit and stevia concentrates, extracts, or powders, other sweetener enhancers, or combinations thereof. The hydrophilic powder may be present in the compound coating at any level that provides a suitable mouthfeel and sweetness. In embodiments, therefore, the compound coating may comprise from greater than or equal to about 20.0 wt % of the hydrophilic powder, such as greater than or equal to about 21.0 wt % of the hydrophilic powder, greater than or equal to about 22.0 wt % of the hydrophilic powder, greater than or equal to about 23.0 wt % of the hydrophilic powder, greater than or equal to about 24.0 wt % of the hydrophilic powder, greater than or equal to about 25.0 wt % of the hydrophilic powder, greater than or equal to about 26.0 wt % of the hydrophilic powder, greater than or equal to about 27.0 wt % of the hydrophilic powder, greater than or equal to about 28.0 wt % of the hydrophilic powder, or greater than or equal to about 29.0 wt % of the hydrophilic powder.

For each of the above ranges, the maximum content of the hydrophilic powder present in the compound coating may be, according to embodiments, about 30.0 wt %. Accordingly, in embodiments, the content of the hydrophilic powder in the compound coating may be from greater than or equal to about 20.0 wt % to less than or equal to about 30.0 wt %, such as from greater than or equal to about 21.0 wt % to less than or equal to about 30.0 wt %, from greater than or equal to about 22.0 wt % to less than or equal to about 30.0 wt %, from greater than or equal to about 23.0 wt % to less than or equal to about 30.0 wt %, from greater than or equal to about 24.0 wt % to less than or equal to about 30.0 wt %, from greater than or equal to about 25.0 wt % to less than or equal to about 30.0 wt %, from greater than or equal to about 26.0 wt % to less than or equal to about 30.0 wt %, from greater than or equal to about 27.0 wt % to less than or equal to about 30.0 wt %, from greater than or equal to about 28.0 wt % to less than or equal to about 30.0 wt %, or from greater than or equal to about 29.0 wt % to less than or equal to about 30.0 wt %. In embodiments, the content of the hydrophilic powder present in the compound coating may be from greater than or equal to about 21.0 wt % to less than or equal to about 29.0 wt %, such as from greater than or equal to about 22.0 wt % to less than or equal to about 28.0 wt %, from greater than or equal to about 23.0 wt % to less than or equal to about 27.0 wt %, or from greater than or equal to about 24.0 wt % to less than or equal to about 26.0 wt %.

Optionally, embodiments of the compound coating may further include one or more additional components that may alter the compound coating's viscosity, mouthfeel, sweetness, flavor, water activity, etc. Suitable additional components may include, but are not limited to, a flavoring agent, a stabilizer, a bulking agent, a preservative, or combinations thereof. In some embodiments, the compound coating may comprise from greater than or equal to about 5.0 wt % of the one or more additional components, such as greater than or equal to about 6.0 wt % of the one or more additional components, greater than or equal to about 7.0 wt % of the one or more additional components, greater than or equal to about 8.0 wt % of the one or more additional components, greater than or equal to about 9.0 wt % of the one or more additional components, greater than or equal to about 10.0 wt % of the one or more additional components, greater than or equal to about 11.0 wt % of the one or more additional components, greater than or equal to about 12.0 wt % of the one or more additional components, greater than or equal to about 13.0 wt % of the one or more additional components, or greater than or equal to about 14.0 wt % of the one or more additional components.

For each of the above ranges, the maximum content the one or more additional components optionally present in the compound coating may be, according to embodiments, about 15.0 wt %. Accordingly, in embodiments, the content of the one or more additional components in the compound coating may be from greater than or equal to about 5.0 wt % to less than or equal to about 15.0 wt %, such as from greater than or equal to about 6.0 wt % to less than or equal to about 15.0 wt %, from greater than or equal to about 7.0 wt % to less than or equal to about 15.0 wt %, from greater than or equal to about 8.0 wt % to less than or equal to about 15.0 wt %, from greater than or equal to about 9.0 wt % to less than or equal to about 15.0 wt %, from greater than or equal to about 10.0 wt % to less than or equal to about 15.0 wt %, from greater than or equal to about 11.0 wt % to less than or equal to about 15.0 wt %, from greater than or equal to about 12.0 wt % to less than or equal to about 15.0 wt %, from greater than or equal to about 13.0 wt % to less than or equal to about 15.0 wt %, or from greater than or equal to about 14.0 wt % to less than or equal to about 15.0 wt %. In embodiments, the content of the one or more additional components present in the compound coating may be from greater than or equal to about 6.0 wt % to less than or equal to about 14.0 wt %, such as from greater than or equal to about 7.5 wt % to less than or equal to about 12.5 wt %, from greater than or equal to about 8.0 wt % to less than or equal to about 12.0 wt %, or from greater than or equal to about 9.0 wt % to less than or equal to about 11.0 wt %.

Overall, regardless of the exact composition of the compound coating, the compound coating may comprise any amount of solid particulates suitable to provide the compound coating with a desirable flavor, mouthfeel, viscosity, water activity, etc. Accordingly, in embodiments, the compound coating comprises from greater than or equal to about 71.0% of solid particulates, such as greater than or equal to about 72.0 wt %, greater than or equal to about 73.0 wt %, or greater than or equal to about 74.0 wt %.

In some embodiments, the maximum content of the solid particulates in the compound coating may be about 75.0 wt %. Accordingly, in some embodiments, the content of solid particulates in the compound coating may be from greater than or equal to about 71.0 wt % to less than or equal to about 75.0 wt %, such as from greater than or equal to about 72.0 wt % to less than or equal to about 75.0 wt %, from greater than or equal to about 73.0 wt % to less than or equal to about 75.0 wt %, or from greater than or equal to about 74.0 wt % to less than or equal to about 75.0 wt %. In some embodiments, the content of the solid particulates in the first layer 110 may be from greater than or equal to about 71.5 wt % to less than or equal to about 74.5 wt %, such as from greater than or equal to about 72.0 wt % to less than or equal to about 74.0 wt %, or from greater than or equal to about 72.5 wt % to less than or equal to about 73.5 wt %.

According to embodiments, the contents of the compound coating may be balanced so that the compound coating has a water activity, as measured by a water activity meter at 25.0 degrees Celsius±0.5 degrees Celsius, of greater than about 0.25, such as a water activity of greater than about 0.26, a water activity of greater than about 0.27, a water activity of greater than about 0.28, a water activity of greater than about 0.29, a water activity of greater than about 0.30, a water activity of greater than about 0.31, a water activity of greater than about 0.32, a water activity of greater than about 0.33, or a water activity of greater than about 0.34.

In some embodiments, the maximum water activity of the compound coating may be about 0.35. Accordingly, in some embodiments, the contents of the compound coating may be balanced so that the water activity of the compound coating may be from greater than or equal to about 0.25 to less than or equal to about 0.35, such as a water activity of greater than or equal to about 0.26 to less than or equal to about 0.35, a water activity of greater than or equal to about 0.27 to less than or equal to about 0.35, a water activity of greater than or equal to about 0.28 to less than or equal to about 0.35, a water activity of greater than or equal to about 0.29 to less than or equal to about 0.35, a water activity of greater than or equal to about 0.30 to less than or equal to about 0.35, a water activity of greater than or equal to about 0.31 to less than or equal to about 0.35, a water activity of greater than or equal to about 0.32 to less than or equal to about 0.35, a water activity of greater than or equal to about 0.33 to less than or equal to about 0.35, or a water activity of greater than or equal to about 0.34 to less than or equal to about 0.35.

In some embodiments, the water activity of the first layer 110 may be from greater than or equal to about 0.26 to less than or equal to about 0.34, from greater than or equal to about 0.27 to less than or equal to about 0.33, from greater than or equal to about 0.28 to less than or equal to about 0.32, or from greater than or equal to about 0.29 to less than or equal to about 0.31.

Regardless of the exact composition selected for the compound coating, the compound coating may be present in the first layer 110 at any suitable level. According to embodiments, the first layer 110 may comprise greater than or equal to about 10.0 wt % of the compound coating, such as greater than or equal to about 12.5 wt % of the compound coating, greater than or equal to about 15.0 wt % of the compound coating, greater than or equal to about 17.5 wt % of the compound coating, greater than or equal to about 20.0 wt % of the compound coating, greater than or equal to about 22.5 wt % of the compound coating, greater than or equal to about 25.0 wt % of the compound coating, or greater than or equal to about 27.5 wt % of the compound coating.

For each of the above ranges, the maximum content of the compound coating present in the first layer 110 may be, according to embodiments, about 30.0 wt %. Accordingly, in embodiments, the content of the compound coating in the first layer 110 may be from greater than or equal to about 10.0 wt % to less than or equal to about 30.0 wt %, such as from greater than or equal to about 12.5 wt % to less than or equal to about 30.0 wt %, from greater than or equal to about 15.0 wt % to less than or equal to about 30.0 wt %, from greater than or equal to about 17.5 wt % to less than or equal to about 30.0 wt %, from greater than or equal to about 20.0 wt % to less than or equal to about 30.0 wt %, from greater than or equal to about 22.5 wt % to less than or equal to about 30.0 wt %, from greater than or equal to about 25.0 wt % to less than or equal to about 30.0 wt %, or from greater than or equal to about 27.5 wt % to less than or equal to about 30.0 wt %. In embodiments, the content of the compound coating present in the first layer 110 may be from greater than or equal to about 12.0 wt % to less than or equal to about 28.0 wt %, such as from greater than or equal to about 14.0 wt % to less than or equal to about 26.0 wt %, from greater than or equal to about 15.0 wt % to less than or equal to about 25.0 wt %, from greater than or equal to about 16.0 wt % to less than or equal to about 24.0 wt %, from greater than or equal to about 18.0 wt % to less than or equal to about 22.0 wt %, or from greater than or equal to about 19.0 wt % to less than or equal to about 21.0 wt %.

As disclosed above, the first layer 110 further comprises a fat source. As used herein, the term “fat source” may be used broadly to refer to any suitable agent that provides the first layer 110 with an additional fat content. In embodiments, the fat source may comprise or consist of high-melting fats, and in embodiments, the fat source may comprise or consist of non-high-melting fats. As such, the fat source may include palm kernel oil, coconut oil, cocoa butter, palm oil, anhydrous milk fat, propylene glycol, glycerin, glycerol, chocolate, fractionated palm oil, double fractionated palm oil, fully hydrogenated coconut palm and palm kernel oils, interesterified vegetable oil, partially hydrogenated oil, animal fat, shortening, or combinations thereof.

Accordingly, in embodiments, the content of the fat source in the first layer 110 may be greater than or equal to about 10.0%, such as greater than or equal to about 12.0 wt %, greater than or equal to about 14.0 wt %, greater than or equal to about 16.0 wt %, greater than or equal to about 18.0 wt %, greater than or equal to about 20.0 wt %, greater than or equal to about 22.0 wt %, greater than or equal to about 24.0 wt %, greater than or equal to about 25.0 wt %, greater than or equal to about 26.0 wt %, or greater than or equal to about 28.0 wt %. In some embodiments, the maximum content of the fat source in the first layer 110 may be about 30.0 wt %. Accordingly, in some embodiments, the content of fat source in the first layer 110 may be from greater than or equal to about 10.0 wt % to less than or equal to about 30.0 wt %, such as from greater than or equal to about 12.0 wt % to less than or equal to about 30.0 wt %, from greater than or equal to about 14.0 wt % to less than or equal to about 30.0 wt %, from greater than or equal to about 15.0 wt % to less than or equal to about 30.0 wt %, from greater than or equal to about 16.0 wt % to less than or equal to about 30.0 wt %, from greater than or equal to about 18.0 wt % to less than or equal to about 30.0 wt %, from greater than or equal to about 20.0 wt % to less than or equal to about 30.0 wt %, from greater than or equal to about 22.0 wt % to less than or equal to about 30.0 wt %, from greater than or equal to about 24.0 wt % to less than or equal to about 30.0 wt %, or from greater than or equal to about 25.0 wt % to less than or equal to about 30.0 wt %. In some embodiments, the content of the fat source in the first layer 110 may be from greater than or equal to about 10.0 wt % to less than or equal to about 30.0 wt %, such as from greater than or equal to about 12.0 wt % to less than or equal to about 28.0 wt %, from greater than or equal to about 14.0 wt % to less than or equal to about 26.0 wt %, from greater than or equal to about 15.0 wt % to less than or equal to about 25.0 wt %, from greater than or equal to about 16.0 wt % to less than or equal to about 24.0 wt %, from greater than or equal to about 17.0 wt % to less than or equal to about 23.0 wt %, from greater than or equal to about 18.0 wt % to less than or equal to about 22.0 wt %, or from greater than or equal to about 19.0 wt % to less than or equal to about 21.0 wt %.

Overall, regardless of the exact combination of the crumb particulates, compound coating, and fat source present in the first layer 110, the first layer may comprise any amount of solid particulates suitable to provide the first layer 110 with a desirable flavor, mouthfeel, viscosity, water activity, etc. Accordingly, in embodiments, the first layer 110 comprises from greater than or equal to about 65.0% of solid particulates, such as greater than or equal to about 66.0 wt %, greater than or equal to about 67.0 wt %, greater than or equal to about 68.0 wt %, greater than or equal to about 69.0 wt %, greater than or equal to about 70.0 wt %, greater than or equal to about 71.0 wt %, greater than or equal to about 72.0 wt %, greater than or equal to about 73.0 wt %, greater than or equal to about 74.0 wt %, greater than or equal to about 75.0 wt %, greater than or equal to about 76.0 wt %, greater than or equal to about 77.0 wt %, greater than or equal to about 78.0 wt %, or greater than or equal to about 79.0 wt %.

In some embodiments, the maximum content of the solid particulates in the first layer 110 may be about 80.0 wt %. Accordingly, in some embodiments, the content of solid particulates in the first layer 110 may be from greater than or equal to about 65.0 wt % to less than or equal to about 80.0 wt %, such as from greater than or equal to about 66.0 wt % to less than or equal to about 80.0 wt %, from greater than or equal to about 67.0 wt % to less than or equal to about 80.0 wt %, from greater than or equal to about 68.0 wt % to less than or equal to about 80.0 wt %, from greater than or equal to about 69.0 wt % to less than or equal to about 80.0 wt %, from greater than or equal to about 70.0 wt % to less than or equal to about 80.0 wt %, from greater than or equal to about 71.0 wt % to less than or equal to about 80.0 wt %, from greater than or equal to about 72.0 wt % to less than or equal to about 80.0 wt %, from greater than or equal to about 73.0 wt % to less than or equal to about 80.0 wt %, from greater than or equal to about 74.0 wt % to less than or equal to about 80.0 wt %, from greater than or equal to about 75.0 wt % to less than or equal to about 80.0 wt %, from greater than or equal to about 76.0 wt % to less than or equal to about 80.0 wt %, from greater than or equal to about 77.0 wt % to less than or equal to about 80.0 wt %, from greater than or equal to about 78.0 wt % to less than or equal to about 80.0 wt %, or from greater than or equal to about 79.0 wt % to less than or equal to about 80.0 wt %. In some embodiments, the content of the solid particulates in the first layer 110 may be from greater than or equal to about 66.0 wt % to less than or equal to about 79.0 wt %, such as from greater than or equal to about 67.0 wt % to less than or equal to about 78.0 wt %, from greater than or equal to about 68.0 wt % to less than or equal to about 77.0 wt %, from greater than or equal to about 69.0 wt % to less than or equal to about 76.0 wt %, from greater than or equal to about 70.0 wt % to less than or equal to about 75.0 wt %, from greater than or equal to about 71.0 wt % to less than or equal to about 74.0 wt %, or from greater than or equal to about 72.0 wt % to less than or equal to about 73.0 wt %.

The crumb particulates, a compound coating, a fat source, and, optionally, one or more additional components, present in the first layer 110 may be mixed together to form the first layer 110 by any suitable method. According to embodiments, the crumb particulates, a compound coating, a fat source, and, optionally, one or more additional components are combined into a vessel and mixed at temperatures sufficient to allow for homogenous mixing of the crumb particulates, a compound coating, a fat source, and, optionally, one or more additional components. The mixing may be accomplished by conventional techniques and with conventional equipment known in the art. Once the crumb particulates, a compound coating, a fat source, and, optionally, one or more additional components are combined into a homogenous mixture, the mixture may be cooled to room temperature and may be formed into the first layer 110 by any suitable method and/or mechanism known in the art.

The content of crumb particulates, a compound coating, a fat source, and, optionally, one or more additional components in the first layer 110 may be balanced to control the water activity of the first layer 110 at varying temperatures. In addition to controlling the water activity of the first layer 110, the content of crumb particulates, a compound coating, a fat source, and, optionally, one or more additional components in the first layer 110 may be balanced to control the water activity of the first layer 110. By controlling the water activity of the first layer 110, a first layer may be formulated so that the first layer 110 has a suitable mouth feel.

According to embodiments, the contents of the first layer 110 may be balanced so that the first layer 110 has a water activity, as measured by a water activity meter at 25.0 degrees Celsius±0.5 degrees Celsius, of greater than about 0.20, such as a water activity of greater than about 0.21, a water activity of greater than about 0.22, a water activity of greater than about 0.23, a water activity of greater than about 0.24, a water activity of greater than about 0.25, a water activity of greater than about 0.26, a water activity of greater than about 0.27, a water activity of greater than about 0.28, a water activity of greater than about 0.29, a water activity of greater than about 0.30, a water activity of greater than about 0.31, a water activity of greater than about 0.32, a water activity of greater than about 0.33, a water activity of greater than about 0.34, a water activity of greater than about 0.35, a water activity of greater than about 0.36, a water activity of greater than about 0.37, a water activity of greater than about 0.38, or a water activity of greater than about 0.39.

In some embodiments, the maximum water activity of the first layer 110 may be about 0.40. Accordingly, in some embodiments, the contents of the first layer 110 may be balanced so that the water activity of the first layer 110 may be from greater than or equal to about 0.20 to less than or equal to about 0.40, such as a water activity of greater than or equal to about 0.22 to less than or equal to about 0.40, a water activity of greater than or equal to about 0.24 to less than or equal to about 0.40, a water activity of greater than or equal to about 0.25 to less than or equal to about 0.40, a water activity of greater than or equal to about 0.26 to less than or equal to about 0.40, a water activity of greater than or equal to about 0.28 to less than or equal to about 0.40, a water activity of greater than or equal to about 0.30 to less than or equal to about 0.40, a water activity of greater than or equal to about 0.32 to less than or equal to about 0.40, a water activity of greater than or equal to about 0.34 to less than or equal to about 0.40, a water activity of greater than or equal to about 0.35 to less than or equal to about 0.40, a water activity of greater than or equal to about 0.36 to less than or equal to about 0.40, a water activity of greater than or equal to about 0.38 to less than or equal to about 0.40.

In some embodiments, the water activity of the first layer 110 may be from greater than or equal to about 0.21 to less than or equal to about 0.39, from greater than or equal to about 0.22 to less than or equal to about 0.38, from greater than or equal to about 0.23 to less than or equal to about 0.37, from greater than or equal to about 0.24 to less than or equal to about 0.36, from greater than or equal to about 0.25 to less than or equal to about 0.35, from greater than or equal to about 0.26 to less than or equal to about 0.34, from greater than or equal to about 0.27 to less than or equal to about 0.33, from greater than or equal to about 0.28 to less than or equal to about 0.32, or from greater than or equal to about 0.29 to less than or equal to about 0.31.

The Second Layer

As described above, the second layer 120 of the multilayer edible product 100 may be in contact with, according to embodiments, the first layer 110. According to embodiments, the composition of the second layer 120 of the multilayer edible product 100 has a water activity that may be greater than the water activity of the first layer 110. As described above, when there is a water activity differential between the first layer 110 and the second layer 120 (such as when the water activity of the first layer 110 is lesser than the water activity of the second layer 120), moisture may migrate from the second layer 120 to the first layer 110. It should be understood that the greater the difference between the water activity of the first layer 110 and the second layer 120, the more pronounced the migration of moisture will be.

The composition of the second layer 120 will typically have a water activity that is greater than the water activity of the first layer 110. In embodiments, the second layer 120 may comprise one or more gelled substances, a flavoring component, a thickening agent, or combinations thereof. In particular, the gelled substance may import a water activity to the second layer 120 that is greater than the water activity of the first layer 110. Accordingly, in embodiments, the second layer 120 comprises one or more gelled substances. As used herein, the term “gelled substances” means any water-based substance that may be thickened through the use of additional solids, such as nonfat dry milk, starch, gelatin, gums, or other similar agents. The second layer 120 may also be thickened through culturing mechanisms, such as with cream cheese or other soft cheeses. In certain embodiments, the second layer 120 may include milk derived from cheese, and may optionally include meat or vegetable broths, egg, syrups, or the like. As such, the term “gelled substances” may, according to some embodiments, refer to mascarpone, cream cheese, heavy cream, soft cheese, skim milk, 1% milk, 2% milk, whole milk, whipping cream, heavy cream, custards, fruit curds, or combinations thereof.

According to embodiments, the second layer 120 may comprise greater than or equal to about 30.0 wt % of the one or more gelled substances, such as greater than or equal to about 35.0 wt % of the one or more gelled substances, greater than or equal to about 40.0 wt % of the one or more gelled substances, greater than or equal to about 45.0 wt % of the one or more gelled substances, greater than or equal to about 50.0 wt % of the one or more gelled substances, greater than or equal to about 55.0 wt % of the one or more gelled substances, or greater than or equal to about 60.0 wt % of the one or more gelled substances.

For each of the above ranges, the maximum content of one or more gelled substances present in the second layer 120 may be, according to embodiments, about 90.0 wt %. Accordingly, in embodiments, the content of the one or more gelled substances in the second layer 120 may be from greater than or equal to about 25.0 wt % to less than or equal to about 90.0 wt %, such as from greater than or equal to about 30.0 wt % to less than or equal to about 90.0 wt %, from greater than or equal to about 35.0 wt % to less than or equal to about 90.0 wt %, from greater than or equal to about 40.0 wt % to less than or equal to about 90.0 wt %, from greater than or equal to about 45.0 wt % to less than or equal to about 90.0 wt %, from greater than or equal to about 50.0 wt % to less than or equal to about 90.0 wt %, from greater than or equal to about 55.0 wt % to less than or equal to about 90.0 wt %, or from greater than or equal to about 60.0 wt % to less than or equal to about 90.0 wt %. In embodiments, the content of one or more gelled substances present in the second layer 120 may be from greater than or equal to about 40.0 wt % to less than or equal to about 80.0 wt %, such as from greater than or equal to about 42.0 wt % to less than or equal to about 78.0 wt %, from greater than or equal to about 44.0 wt % to less than or equal to about 76.0 wt %, from greater than or equal to about 46.0 wt % to less than or equal to about 74.0 wt %, from greater than or equal to about 48.0 wt % to less than or equal to about 72.0 wt %, from greater than or equal to about 50.0 wt % to less than or equal to about 70.0 wt %, from greater than or equal to about 52.0 wt % to less than or equal to about 68.0 wt %, from greater than or equal to about 54.0 wt % to less than or equal to about 66.0 wt %, from greater than or equal to about 56.0 wt % to less than or equal to about 64.0 wt %, from greater than or equal to about 58.0 wt % to less than or equal to about 62.0 wt %, or from greater than or equal to about 59.0 wt % to less than or equal to about 61.0 wt %.

In embodiments where the second layer 120 comprises one or more gelled substances, the second layer 120 may further comprise other components, such as a flavoring component, a thickening agent, a preservative, or combinations thereof. As used herein, the term “flavoring component” may be used broadly to refer to any natural or artificial edible agents that provide the second layer 120 with additional flavors. The natural or artificial edible agents may be either dry or liquid. Examples of suitable flavoring components may include, but are not limited to, chocolate, white chocolate, cocoa, jelly, jam, curd, peanuts, tree nuts, coconut paste, butter, caramel, curd, salt, sugar, brown sugar, fruit powders, fruit purees, or combinations thereof. According to embodiments, the second layer 120 may comprise from about 25 wt % to about 90 wt % of the one or more gelled substances, from about 10 wt % to about 30 wt % of the flavoring component, and from about 0.1 wt % to about 5 wt % of the thickening agent. Each of the flavoring component, the thickening agent, and the preservative will be described in more detail below.

As disclosed above, the second layer 120 may comprise a flavoring component in either dry or liquid form. The flavoring component may be, according to embodiments, any natural or artificial flavoring agent, such as chocolate, white chocolate, cocoa, jelly, jam, curd, peanuts, tree nuts, coconut paste, butter, caramel, curd, salt, sugar, brown sugar, fruit powders, fruit purees, syrups, or combinations thereof. In embodiments that include the additional solids, sugar, salt, or combinations thereof, these components may increase the water holding capacity of the second layer 120 absorbing some of the moisture in the second layer 120, which can mitigate some of the migration of moisture from the second layer 120 to the first layer 110. In addition, the additional solids, sugar, salt, or combinations thereof may improve the homogeneity of the second layer 120 composition and provide improved mouthfeel. However, if too much sugar/and or salt is added to the second layer 120, the sugar/and or salt may reduce the moisture of the second layer 120 to a level that may be undesirable, and which may prevent the second layer 120 from achieving a desirable consistency, mouthfeel, and water activity.

Accordingly, in embodiments, the content of flavoring component in the second layer 120 may be greater than or equal to about 0.5%, such as greater than or equal to about 1.0 wt %, greater than or equal to about 2.5 wt %, greater than or equal to about 5.0 wt %, greater than or equal to about 7.5 wt %, greater than or equal to about 10.0 wt %, greater than or equal to about 12.5 wt %, greater than or equal to about 15.0 wt %, greater than or equal to about 17.5 wt %, greater than or equal to about 20.0 wt %, greater than or equal to about 22.5 wt %, greater than or equal to about 25.0 wt %, greater than or equal to about 27.5 wt %, greater than or equal to about 30.0 wt %, greater than or equal to about 32.5 wt %, or greater than or equal to about 35.0 wt %. In some embodiments, the maximum content of the flavoring component in the second layer 120 may be about 40.0 wt %. Accordingly, in some embodiments, the content of flavoring component in the second layer 120 may be from greater than or equal to about 0.5 wt % to less than or equal to about 40.0 wt %, such as from greater than or equal to about 1.0 wt % to less than or equal to about 40.0 wt %, greater than or equal to about 2.5 wt % to less than or equal to about 40.0 wt %, greater than or equal to about 5.0 wt % to less than or equal to about 40.0 wt %, greater than or equal to about 7.5 wt % to less than or equal to about 40.0 wt %, greater than or equal to about 10.0 wt % to less than or equal to about 40.0 wt %, greater than or equal to about 12.5 wt % to less than or equal to about 40.0 wt %, from greater than or equal to about 15.0 wt % to less than or equal to about 40.0 wt %, from greater than or equal to about 17.5 wt % to less than or equal to about 40.0 wt %, from greater than or equal to about 20.0 wt % to less than or equal to about 40.0 wt %, from greater than or equal to about 22.5 wt % to less than or equal to about 40.0 wt %, from greater than or equal to about 25.0 wt % to less than or equal to about 40.0 wt %, from greater than or equal to about 27.5 wt % to less than or equal to about 40.0 wt %, from greater than or equal to about 30.0 wt % to less than or equal to about 40.0 wt %, from greater than or equal to about 32.5 wt % to less than or equal to about 40.0 wt %, or from greater than or equal to about 35.0 wt % to less than or equal to about 40.0 wt %. In some embodiments, the content of the flavoring component in the second layer 120 may be from greater than or equal to about 0.5 wt % to less than or equal to about 25.0 wt %, such as from greater than or equal to about 1.0 wt % to less than or equal to about 25.0 wt %, greater than or equal to about 2.5 wt % to less than or equal to about 25.0 wt %, greater than or equal to about 5.0 wt % to less than or equal to about 25.0 wt %, greater than or equal to about 7.5 wt % to less than or equal to about 25.0 wt %, greater than or equal to about 10.0 wt % to less than or equal to about 25.0 wt %, greater than or equal to about 12.0 wt % to less than or equal to about 25.0 wt %, from greater than or equal to about 14.0 wt % to less than or equal to about 25.0 wt %, from greater than or equal to about 15.0 wt % to less than or equal to about 25.0 wt %, from greater than or equal to about 16.0 wt % to less than or equal to about 24.0 wt %, from greater than or equal to about 17.0 wt % to less than or equal to about 23.0 wt %, from greater than or equal to about 18.0 wt % to less than or equal to about 22.0 wt %, or from greater than or equal to about 19.0 wt % to less than or equal to about 21.0 wt %.

According to embodiments, the second layer 120 may further comprise a thickening agent. In embodiments, the thickening agent may be selected from wheat flour, cornstarch, potato starch, tapioca, arrowroot, pre-gelatinized starch, agar-agar, algin, carrageenan, gelatin, gum Arabic, gum tragacanth, pectin, katakuri starch, sago, almond flour, guar gum, locust bean gum, xanthan gum, dextrin, cyclodextrin, maltodextrin, rice flour, food starch, modified food starch, modified corn starch, wheat starch, oat fiber, citrus fiber, or combinations thereof. As will be discussed in more detail below, controlling the viscosity of the second layer 120 allows for a multilayer edible product 100 with a second layer 120 that may be homogenous, which results in a desirable mouth feel. The thickening agent may be added in amounts that help to control the viscosity and improve the water holding capacity of the second layer 120 at varying temperatures. According to embodiments, the content of the thickening agent in the second layer 120 may be greater than or equal to about 0.01 wt %, such as greater than or equal to about 0.1 wt %, greater than or equal to about 0.5 wt %, greater than or equal to about 1.0 wt %, greater than or equal to about 2.5 wt %, or greater than or equal to about 5.0 wt %. In some embodiments, the maximum content of the thickening agent in the second layer 120 may be about 10.0 wt %. Accordingly, in embodiments, the content of the thickening agent in the second layer 120 may be from greater than or equal to about 0.01 wt % to less than or equal to about 10.0 wt %, such as from greater than or equal to about 0.1 wt % to less than or equal to about 10.0 wt %, from greater than or equal to about 0.5 wt % to less than or equal to about 10.0 wt %, from greater than or equal to about 1.0 wt % to less than or equal to about 10.0 wt %, from greater than or equal to about 2.5 wt % to less than or equal to about 10.0 wt %, or from greater than or equal to about 5.0 wt % to less than or equal to about 10.0 wt %. In some embodiments, the content of the thickening agent in the second layer 120 may be from greater than or equal to about 1.0 wt % to less than or equal to about 9.0 wt %, from greater than or equal to about 1.0 wt % to less than or equal to about 8.0 wt %, from greater than or equal to about 1.0 wt % to less than or equal to about 7.0 wt %, from greater than or equal to about 1.0 wt % to less than or equal to about 6.0 wt %, or from greater than or equal to about 1.0 wt % to less than or equal to about 5.0 wt %.

A preservative may optionally be added to embodiments of the second layer 120 to preserve the second layer 120 from decay or spoliation. In embodiments, the preservative may include natural preservatives, artificial preservatives, or combinations thereof. In one or more embodiments the preservative may be selected from sorbic acid, citric acid, acetic acid, fumaric acid, lactic acid, phosphoric acid, malic acid, tartaric acid, sodium sorbate, benzoic acid, benzoates, parabens, sulfur dioxide, sulfites, nitrites, nitrates, propionic acid, propionates, cultured milk, cultured dextrose, cultured vinegar, potassium sorbate, cultured dairy, natamycin, nisin, or combinations thereof. As stated above, the preservative may be an optional component of the second layer 120, thus in embodiments disclosed and described herein, the second layer 120 may not include any preservatives. Accordingly, in embodiments, the content of the preservative in the second layer 120 may be greater than or equal to about 0.0 wt %, such as greater than or equal to about 0.0001 wt %, greater than or equal to about 0.001 wt %, greater than or equal to about 0.01 wt %, greater than or equal to about 0.1 wt %, or greater than or equal to about 1.0 wt %. In some embodiments, the maximum content of the preservative in the second layer 120 may be about 4.0 wt %. Accordingly, in embodiments, the content of the preservative in the second layer 120 may be from greater than or equal to about 0.0 wt % to less than or equal to about 4.0 wt %, such as from greater than or equal to about 0.0001 wt % to less than or equal to about 4.0 wt %, from greater than or equal to about 0.001 wt % to less than or equal to about 4.0 wt %, from greater than or equal to about 0.01 wt % to less than or equal to about 4.0 wt %, from greater than or equal to about 0.1 wt % to less than or equal to about 4.0 wt %, from greater than or equal to about 1.0 wt % to less than or equal to about 4.0 wt %, from greater than or equal to about 2.0 wt % to less than or equal to about 4.0 wt %, or from greater than or equal to about 3.0 wt % to less than or equal to about 4.0 wt %. In embodiments, the content of the preservative in the second layer 120 may be from greater than or equal to about 0.0 wt % to less than or equal to about 1.0 wt %, such as from greater than or equal to about 0.0001 wt % to less than or equal to about 1.0 wt %, from greater than or equal to about 0.001 wt % to less than or equal to about 1.0 wt %, from greater than or equal to about 0.01 wt % to less than or equal to about 1.0 wt %, from greater than or equal to about 0.1 wt % to less than or equal to about 1.0 wt %, or from greater than or equal to about 0.5 wt % to less than or equal to about 1.0 wt %.

The one or more gelled substances, flavoring component, thickening agent, and, optionally, preservative may be mixed together to form the second layer 120 by any suitable method. According to embodiments, the one or more gelled substances, flavoring component, thickening agent, and, optionally, preservative are combined into a vessel and mixed at temperatures sufficient to allow for homogenous mixing of the one or more gelled substances, flavoring component, thickening agent, and, optionally, preservative. The mixing may be accomplished by conventional techniques and with conventional equipment known in the art. Once the one or more gelled substances, flavoring component, thickening agent, and, optionally, preservative are combined into a homogenous mixture, the mixture may be cooled to room temperature or refrigerated temperatures and may be formed into the second layer 120 by any suitable method and/or mechanism known in the art.

The content of one or more gelled substances, flavoring component, thickening agent, and, optionally, preservative in the second layer 120 may be balanced to control the water activity of the second layer 120 at varying temperatures. In addition to controlling the water activity of the second layer 120, the content of one or more gelled substances, flavoring component, thickening agent, and, optionally, preservative in the second layer 120 may be balanced to control the viscosity, water holding capacity, and/or relaxation time of the second layer 120. By controlling the water activity, viscosity, water holding capacity, and/or relaxation time of the second layer 120, a second layer may be formulated so that the second layer 120 has a suitable mouth feel.

A frequency sweep test at 50° C. was used to measure linear viscoelastic properties of the second layer, from which the water holding capacity of the second layer could be determined. Rheological measurements were carried out on an ARES-G2 rheometer equipped with a 25 mm cross-hatched parallel plate and a 50 mm cross-hatched bottom plate. The rheometer was used with a geometry gap of 2 mm. A temperature ramp test was conducted at a loading temperature of 30° C. and a test temperature of 5° C. The strain is 0.5%, frequency is 10 radians per second (rad/s) with a sampling rate of 10 points/decade. The tests were repeated until two overlaying curves were obtained for heating RTA.

According to embodiments, the contents of the second layer 120 may be balanced so that the second layer 120 has a water activity of greater than about 0.75, such as a water activity of greater than about 0.76, a water activity of greater than about 0.77, a water activity of greater than about 0.78, a water activity of greater than about 0.79, a water activity of greater than about 0.80, a water activity of greater than about 0.81, a water activity of greater than about 0.82, a water activity of greater than about 0.83, a water activity of greater than about 0.84, a water activity of greater than about 0.85, a water activity of greater than about 0.86, a water activity of greater than about 0.87, a water activity of greater than about 0.88, a water activity of greater than about 0.89, a water activity of greater than about 0.90, a water activity of greater than about 0.91, a water activity of greater than about 0.92, a water activity of greater than about 0.93, a water activity of greater than about 0.94, or a water activity of greater than about 0.95. In some embodiments, the maximum water activity of the second layer 120 may be about 0.95. Accordingly, in some embodiments, the contents of the second layer 120 may be balanced so that the water activity of the second layer 120 may be from greater than or equal to about 0.75 to less than or equal to about 0.95, such as a water activity of greater than or equal to about 0.76 to less than or equal to about 0.95, a water activity of greater than or equal to about 0.77 to less than or equal to about 0.95, a water activity of greater than or equal to about 0.78 to less than or equal to about 0.95, a water activity of greater than or equal to about 0.79 to less than or equal to about 0.95, a water activity of greater than or equal to about 0.80 to less than or equal to about 0.95, a water activity of greater than or equal to about 0.81 to less than or equal to about 0.95, a water activity of greater than or equal to about 0.82 to less than or equal to about 0.95, a water activity of greater than or equal to about 0.83 to less than or equal to about 0.95, a water activity of greater than or equal to about 0.84 to less than or equal to about 0.95, a water activity of greater than or equal to about 0.85 to less than or equal to about 0.95. In some embodiments, the water activity of the second layer 120 may be from greater than or equal to about 0.75 to less than or equal to about 0.92, from greater than or equal to about 0.76 to less than or equal to about 0.89, from greater than or equal to about 0.77 to less than or equal to about 0.86, from greater than or equal to 0.78 to less than or equal to about 0.83, from greater than or equal to about 0.78 to less than or equal to about 0.82, or from greater than or equal to about 0.79 to less than or equal to about 0.81.

Multilayer Edible Product

As described above, and with reference to FIG. 1, the multilayer edible product 100 comprises a first layer 110 and a second layer 120. The multilayer edible product 100 may be produced by individually mixing each layer by any available means and then formed into a layered product by any suitable method or equipment capable of forming the multilayer product. According to some embodiments, the multilayer edible product 100 may be formed by co-extrusion.

In one or more embodiments, the first layer 110 may be prepared by melting the fat contents of the first layer 110 and then slowly adding the melted fat contents to a mixture of the crumb particulates. By melting the fat contents, the fat contents may fully coat the crumb particulates. The fat contents may be heated to a high enough temperature that allows the fat contents to coat the crumb particulates, but not to such a high temperature as to allow the fat contents to absorb into the crumb particulates. After the compound coating including the high-melting fat, fat source, and crumb particulates are mixed together into the first layer 110, the first layer 110 may be allowed to return to room temperature without baking the first layer 110. By baking and driving moisture out of first layer 110, the rate of moisture absorption of the first layer 110 may increase once the first layer 110 is combined with the second layer 120 into multilayer edible product 100.

In one or more embodiments, the second layer 120 may be prepared by melting the flavoring component and the one or more gelled substances so that the flavoring component and the one or more gelled substances are easily miscible. Then, the flavoring component and the one or more gelled substances may be blended into a homogenous composition. Once a desirable composition is achieved, the thickening agent may be added while heat and shear are applied. The mixture may then be partially cooled to form the second layer 120.

Once the first layer 110 and the second layer 120 have been prepared, the two layers may be added to a vessel in any manner. In embodiments, the first layer 110 may be added to the vessel before the second layer 120. A vibration may be then applied to the container so that the first layer 110 spreads evenly across a bottom of the vessel. The vessel with the first layer 110 may then be sent through a cooler or given adequate time so that the first layer 110 may solidify. Once the first layer 110 is sufficiently solidified, the second layer 120 may then be applied to a top surface of the first layer 110 within the vessel. The vessel, which now includes the multilayer edible product 100 may then be cooled until consumption.

The multilayer edible product 100, in embodiments, mitigates moisture migration from the wet, second layer 120 to the dry, first layer 110 for at least about 28 days. In some embodiments the multilayer edible product 100 mitigates moisture migration from the wet, second layer 120 to the dry, first layer 110 for at least about 35 days, at least about 42 days, at least about 49 days, at least about 56 days, at least about 63 days, or at least about 70 days. In one or more embodiments, the multilayer edible product 100 mitigates moisture migration from the wet, second layer 120 to the dry, first layer 110 from greater than or equal to about 28 days to less than or equal to about 149 days, from greater than or equal to about 35 days to less than or equal to about 142 days, from greater than or equal to about 42 days to less than or equal to about 135 days, from greater than or equal to about 49 days to less than or equal to about 128 days, from greater than or equal to about 56 days to less than or equal to about 120 days, from greater than or equal to about 63 days to less than or equal to about 120 days, or from greater than or equal to about 70 days to less than or equal to about 120 days.

The embodiments described herein will be further clarified by the following examples.

### Examples

Multilayer edible products according to embodiments disclosed and described herein were produced using the following ingredients for the first layer and the second layer.

A first layer was formed by mixing the ingredients shown in Table 1 below until well mixed. The compound coating included a blend of coconut oil, confectioner's sugar, whey, soy lecithin, and salt. The compound coating was comprised of 73% solids, had a water activity of about 0.30, and had a fat content of 59%. To prepare the first layer, the anhydrous milk fat and the compound coating were melted. Then, the melted anhydrous milk fat and compound coating were combined with the crumb particulates until a homogenous mixture was achieved.

TABLE 1

| | Weight |
|---|---|
| Ingredient | Percent |
| Cookie Crumbs | 61.4 |
| Compound Coating | 19.3 |
| Anhydrous Milk Fat | 19.3 |
| Total | 100 |

A second layer was formed by mixing the ingredients shown in Table 2 below until a homogenous mixture was achieved.

TABLE 2

| | Weight |
|---|---|
| Ingredient | Percent |
| Mascarpone | 47.5 |
| Heavy Cream | 32.5 |
| Flavor Component | 20 |
| Total | 100 |

A multilayer edible product was then formed by taking the warm first layer and pressing a thin layer about 0.25 inches thick into a 4 ounce soufflé cup. Then, the warm first layer was allowed to cool into a solid first layer. Next, the second layer was applied on top of the first layer. The second layer was densely applied at a thickness of about 1.50 inches such that the first layer was completely covered by the second layer, thus forming the multilayer edible product.

From the multilayer edible product formed according to this method, it was found that the compositions of the first layer and second layer prevented moisture migration from the second layer to the first layer for 70 days. It was found that such an elevated amount of high-melting fat in the first layer was critical to preventing moisture migration. The upper limit of the high-melting fat in the first layer was dictated by taste preferences.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A multilayer edible product comprising:
a first layer having a water activity from 0.20 to 0.40; and
a second layer having a water activity greater than 0.75; wherein
the first layer comprises at least 20 wt % of high-melting fats and mitigates moisture migration from the second layer to the first layer.

2. The multilayer edible product of claim 1, wherein the first layer comprises crumb particulates, a compound coating, and a fat source.

3. The multilayer edible product of claim 2, wherein the first layer comprises from 50 wt % to 70 wt % of the crumb particulates, from 10 wt % to 30 wt % of the compound coating, and from 10 wt % to 30 wt % of the fat source.

4. The multilayer edible product of claim 2, wherein the fat source comprises palm kernel oil, coconut oil, cocoa butter, palm oil, anhydrous milk fat, propylene glycol, glycerin, glycerol, chocolate, fractionated palm oil, double fractionated palm oil, fully hydrogenated coconut palm and palm kernel oils, interesterified vegetable oil, partially hydrogenated oil, animal fat, shortening, or combinations thereof

5. The multilayer edible product of claim 2, wherein the crumb particulates comprise fragments of one or more grain-based carbohydrate elements.

6. The multilayer edible product of claim 5, wherein the crumb particulates comprise breadcrumbs, cake crumbs, cookie crumbs, crackers, or combinations thereof.

7. The multilayer edible product of claim 2, wherein the compound coating comprises edible high-melting fat and hydrophilic powder.

8. The multilayer edible product of claim 7, wherein the compound coating further comprises whey, lecithin, salt, or combinations thereof.

9. The multilayer edible product of claim 7, wherein the edible high-melting fat comprises coconut oil, anhydrous milk fat, palm oil, chocolate, cocoa butter, fractionated palm oil, double fractionated palm oil, fully hydrogenated coconut palm and palm kernel oils, palm kernel oil, interesterified vegetable oil, partially hydrogenated oil, animal fat, shortening, or combinations thereof.

10. The multilayer edible product of claim 7, wherein the compound coating comprises from 50 wt % to 70 wt % of the high-melting fat and from 20 wt % to 30 wt % of the hydrophilic powder.

11. The multilayer edible product of claim 1, wherein the second layer comprises one or more gelled substances, a flavoring component, and a thickening agent.

12. The multilayer edible product of claim 11, wherein the one or more gelled substances comprise mascarpone, cream cheese, heavy cream, soft cheese, skim milk, 1% milk, 2% milk, whole milk, whipping cream, heavy cream, custards, or combinations thereof.

13. The multilayer edible product of claim 11, wherein the flavoring component comprises chocolate, white chocolate, cocoa, jelly, jam, curd, peanuts, tree nuts, coconut paste, butter, caramel, curd, salt, sugar, brown sugar, fruit powders, fruit purees, or combinations thereof.

14. The multilayer edible product of claim 11, wherein the second layer comprises from 25 wt % to 90 wt % of the one or more gelled substances, from 0.5 wt % to 30 wt % of the flavoring component, and from 0.1 wt % to 10 wt % of the thickening agent.

15. The multilayer edible product of claim 1, wherein the first layer comprising the high-melting fats mitigates moisture migration from the second layer to the first layer for at least 70 days.

16. A first food layer comprising:
50 wt % to 70 wt % of crumb particulates comprising fragments of breadcrumbs, cake crumbs, cookie crumbs, crackers, or combinations thereof;
10 wt % to 30 wt % of a compound coating comprising an edible high-melting fat; and
10 wt % to 30 wt % of a fat source;
wherein the edible high-melting fat and the fat source mitigate moisture migration into the first food layer from a second food layer;
wherein the first food layer has a water activity from 0.20 to 0.40; and
wherein the second food layer has a water activity greater than 0.75.

17. The first food layer of claim 16, wherein the edible high-melting fat comprises coconut oil, anhydrous milk fat, palm oil, chocolate, cocoa butter, fractionated palm oil, double fractionated palm oil, fully hydrogenated coconut palm and palm kernel oils, palm kernel oil, interesterified vegetable oil, partially hydrogenated oil, animal fat, shortening, or combinations thereof.

18. The first food layer of claim 16, wherein the fat source comprises palm kernel oil, coconut oil, cocoa butter, palm oil, anhydrous milk fat, propylene glycol, glycerin, glycerol, chocolate, fractionated palm oil, double fractionated palm oil, fully hydrogenated coconut palm and palm kernel oils, interesterified vegetable oil, partially hydrogenated oil, animal fat, shortening, or combinations thereof.

19. The first food layer of claim 16 wherein the edible high-melting fat and the fat source coat the crumb particulates.

20. The first food layer of claim 19 wherein the first layer is not baked.
